(19) United States
(12) Patent Application Publication
(10) Pub. No.: US 2025/0369508 A1
(43) Pub. Date: Dec. 4, 2025

(54) HEAT SHIELDING AIR FUNNEL

(71) Applicant: BOMBARDIER RECREATIONAL PRODUCTS INC., Valcourt (CA)

(72) Inventors: Christian MAHEUX, Sherbrooke (CA); David BROUILLETTE, Drummondville (CA)

(73) Assignee: BOMBARDIER RECREATIONAL PRODUCTS INC., Valcourt (CA)

(21) Appl. No.: 19/209,883

(22) Filed: May 16, 2025

Related U.S. Application Data
(60) Provisional application No. 63/654,342, filed on May 31, 2024.

(51) Int. Cl. F16H 57/04; F16H 9/00

(52) U.S. Cl. CPC F16H 57/0417; F16H 9/00

(57) ABSTRACT

A method and apparatus for heat management in a side-by-side off-road vehicle having an engine and a continuously variable transmission (CVT) including a cooling system with a CVT cooling intake and a CVT cooling exhaust. The method and apparatus directs CVT cooling exhaust over at least a portion of the exhaust pipe of the engine and to shield heat from the occupant and cargo spaces of the vehicle. The apparatus includes at least one section that concentrically covers the exhaust pipe and channels airflow from the CVT cooling exhaust over the exhaust pipe to be emitted towards the muffler area at the rear of the vehicle.

This application claims priority from U.S. Provisional Application No. 63/654,342 filed on May 31, 2024, “HEAT SHIELDING AIR FUNNEL”, the content of each being hereby incorporated by reference in its entirety.

### TECHNICAL FIELD

The invention relates to heat management within side-by-side vehicles. More particularly, the invention relates to moving heat from compact engines away from the vehicle operator compartment through heat shielding that channels airflow.

### BACKGROUND OF THE ART

In the field of vehicles having internal combustion engines, waste heat that is produced by the engine and related components provides unwanted heating of the corresponding passenger compartment adjacent to the engine compartment. This requires mechanisms to prevent or otherwise shield heat within the engine compartment from the passengers and the vehicle environment exposed to the passengers. In terms of compact vehicles, this concern is even more accentuated. Indeed, heat management is a challenge in a side-by-side vehicle (SSV) for all-terrain use which is inherently constrained in terms of keeping the functional components of the engine as compact as possible while maintaining a desirable level of comfort for the operator and passenger(s).

In particular, heat must be evacuated from SSVs to improve comfort of the vehicle occupants and to avoid overheating components and cargo box surfaces of the SSV. Excessive heat from an engine exhaust pipe may range up to about 700° C. to 800° C. and the related air-cooling for continuously variable transmission (CVT) exhaust typically found in SSVs may range up to about 100° C. to 120° C. To compensate for the heat generated, these exhaust pipes need to be as short as possible to hasten egress of heated gases from the vehicle and also shielded from other components. In current configurations, for instance, the engine exhaust is protected by a heat shield which is primarily an arrangement of metallic sheets or ducts covering the engine exhaust but spaced therefrom. Such spacing is often problematic. For example, space under the cargo box is limited and it is desirable to have a clearance dimension that is as large as possible.

Accordingly, compact and more efficient configurations of air intakes, engine and transmission assemblies, and exhaust components are thus desirable. What is therefore needed is a heat management mechanism to alleviate one or more defects of the prior arrangements.

### SUMMARY

The present disclosure provides a method and apparatus for heat management in a side-by-side off-road vehicle having an engine and a CVT including a cooling system with a CVT cooling intake and a CVT cooling exhaust. The method and apparatus directs CVT cooling exhaust over at least a portion of the exhaust pipe of the engine and to shield heat from the occupant and cargo spaces of the vehicle. The apparatus includes at least one section that concentrically covers the exhaust pipe and channels airflow from the CVT cooling exhaust over the exhaust pipe to be emitted towards the muffler area at the rear of the vehicle.

In one embodiment, the present disclosure provides a heat management apparatus for use in a side-by-side off-road vehicle having an engine and a CVT including a cooling system with a CVT cooling intake and a CVT cooling exhaust, the apparatus comprising: a first section partially open and attachable to an engine exhaust manifold of the engine, the first section having a first end and a second end, the first end configured for engagement with the CVT cooling exhaust; a second section arranged concentrically around a portion of an exhaust pipe that extends from the engine exhaust manifold to an area near a muffler of the vehicle, the second section attached to the second end of the first section; and upon attachment of the first section to the engine exhaust manifold, the first section and the second section form a flow path surrounding the engine exhaust manifold and at least a portion of the exhaust pipe.

The present disclosure also provides that the flow path surrounds the engine exhaust pipe for a length of at least 20 cm, for a length of at least 40 cm, for a length of at least 60 cm, and for a length of between 70 cm and 80 cm.

In another embodiment, the present disclosure provides a side-by-side off-road vehicle comprising: an engine having an engine exhaust manifold, an exhaust pipe extending from the manifold, and a muffler attached to the exhaust pipe at a distance from the manifold, and the manifold and exhaust pipe form an engine exhaust conduit; a CVT including a CVT cooling system with a CVT cooling intake and a CVT cooling exhaust: a heat shielding air funnel having a first section engaging the manifold, the first section having a first end and a second end, the first end engaging the CVT cooling exhaust, and a second section arranged concentrically around a portion of the exhaust pipe between the manifold and the muffler, the second section attached to the second end of the first section; and the first section and the second section form a flow path surrounding the engine exhaust manifold and the portion of the exhaust pipe.

The present disclosure also provides that the flow path surrounds the engine exhaust pipe for a length of at least 20 cm, for a length of at least 40 cm, for a length of at least 60 cm, or for a length of between 70 cm and 80 cm.

The present disclosure also provides that at least part of the CVT cooling exhaust spans over at least 30%, at least 50%, at least 70%, or substantially over an entirety of the flow path.

The present disclosure also provides that the engine exhaust conduit spans over at least 30%, at least 50%, at least 70%, or substantially over an entirety of the flow path between the manifold and the muffler.

The present disclosure also provides that the CVT cooling exhaust is configured to cool engine exhaust gases along at least a segment of the exhaust conduit.

The present disclosure also provides an air speed of the CVT cooling exhaust in the flow path is at least 10 m/s, at least 15 m/s, and more specifically at least 20 m/s.

The present disclosure also provides an air flow of the CVT cooling system is at least 90 CFM (153 m³/h), 135 CFM (230 m³/h), or 180 CFM (305 m³/h).

The present disclosure also provides that the engine exhaust flow through the engine exhaust conduit is at least 200 kg/h, at least 250 kg/h, or more specifically at least 290 kg/h.

The present disclosure also provides that the engine exhaust flow through the engine exhaust conduit is at least 500 m³/h, at least 625 m³/h, and more specifically about 750 m³/h.

The present disclosure also provides an outer diameter of the second section is between 60 mm and 100 mm or between 73 mm and 87 mm.

The present disclosure also provides that the spacing between an inner wall of the second section and an outer wall of the exhaust pipe is between 15 mm and 20 mm, and more specifically about 18 mm.

The present disclosure also provides that a maximum outer temperature of the heat shielding air funnel is no more than 120° C. along a majority or an entirety of the exhaust conduit.

The present disclosure also provides that the second section further includes at least one reinforcing element extending radially between the exhaust pipe and the inner wall of the second section to maintain the second section in place.

The present disclosure also provides that the first section and the second section are connected by resilient elements.

The present disclosure also provides that the resilient elements are springs.

The present disclosure also provides that the number of springs is at least two.

The present disclosure also provides that the resilient elements are configured to limit mechanical load variations due to temperature and gas flow variations during use of the vehicle.

The present disclosure also provides that the engine and the CVT are transverse.

The present disclosure also provides that an exit port of the heat shielding air funnel is configured to direct CVT exhaust air generally toward a rear of the vehicle at a distal end of the second section.

The present disclosure also provides that an exit port of the heat shielding air funnel is configured to direct CVT exhaust air generally toward the muffler.

The present disclosure also provides that the second section includes an element proximate to a distal end of the second section, the element configured to split airflow emitted from the flow path into at least a first part and a second part.

The present disclosure also provides that the second section is configured to direct the first part of the airflow toward a first portion of the muffler and to direct the second part of the airflow toward a second portion of the muffler.

The present disclosure also provides that the second section is configured to direct the first part of the airflow toward the muffler and to direct the second part of the airflow toward another component of the vehicle.

The present disclosure also provides that the muffler extends laterally such that air flows in the muffler generally in a lateral direction of the vehicle.

The present disclosure also provides that the muffler outputs air flow on a side of the muffler.

The present disclosure also provides that the muffler outputs air flow toward a rear of the vehicle.

The present disclosure also provides that the heat shielding air funnel is configured to create a turbulent flow around at least part of the engine exhaust conduit to manage temperature of the engine exhaust conduit.

In another embodiment, the present disclosure provides a method of heat management within a vehicle that includes an engine with an engine exhaust conduit and a continuously variable transmission (CVT) with a CVT cooling system, the method comprising: receiving CVT exhaust gases from the CVT cooling system into a heat shielding air funnel; exposing the CVT exhaust gases to an outer surface of the engine exhaust conduit; and emitting the CVT exhaust gases towards a distal end of the engine exhaust conduit.

The present disclosure also provides that the exposing includes at least partly surrounding the engine exhaust conduit by the heat shielding air funnel.

In another embodiment, the present disclosure provides a method of managing exhaust conduit temperature within a vehicle that includes an engine with an engine exhaust conduit and a continuously variable transmission (CVT) with a CVT cooling system, the method comprising: receiving CVT exhaust gases from the CVT cooling system into a heat shielding air funnel; exposing the CVT exhaust gases to an outer surface of the engine exhaust conduit; extracting heat from the engine exhaust conduit through the outer surface into the CVT exhaust gases surrounding the engine exhaust conduit; and emitting the CVT exhaust gases towards a distal end of the engine exhaust conduit.

The present disclosure also provides that the exposing includes at least partly surrounding the engine exhaust conduit by the heat shielding air funnel.

The present disclosure also provides that the exposing includes at least partly surrounding the engine exhaust conduit by the heat shielding air funnel.

In another embodiment, the present disclosure provides a vehicle with a powertrain having a periphery and including an engine and a transmission, the vehicle comprising: a plurality of exhaust ports; a plurality of exhaust locations along the periphery, each location being where exhaust conduits of the engine and the transmission each intersect the periphery to direct exhaust gases outside of an area occupied by the powertrain; and the number of exhaust ports is greater than the number of exhaust locations.

### BRIEF DESCRIPTION OF THE DRAWINGS

Having thus generally described the nature of the invention, reference will now be made to the accompanying drawings, showing by way of illustration example embodiments thereof and in which:

FIG. 1 is a perspective view of a side-by-side all terrain vehicle within which an embodiment of a heat shielding air funnel may be found;

FIG. 2 is a partial view of a rear engine compartment of the vehicle shown in FIG. 1 with the cargo bed and heat plates removed and within which a generalized schematic the heat shielding air funnel is illustrated;

FIG. 3 is a top view of an engine block for the vehicle of FIG. 1 within which the embodiment of the heat shielding air funnel is illustrated;

FIG. 4 is a side perspective view of the embodiment of the heat shielding air funnel is shown with an associated muffler exhaust portion;

FIG. 5 is a top perspective view of the embodiment of the heat shielding air funnel as shown in FIG. 4;

FIG. 6 is an end view taken from the cross section B-B in FIG. 5;

FIG. 7 is an end view taken from the cross section A-A in FIG. 4;

FIG. 8 is a close-up view of a portion of the heat shielding air funnel;

FIG. 9 is rear view of another embodiment of the heat shielding air funnel within an engine having a single exhaust CVT; and

FIG. 10 is side perspective view the embodiment shown in FIG. 9.

### DETAILED DESCRIPTION

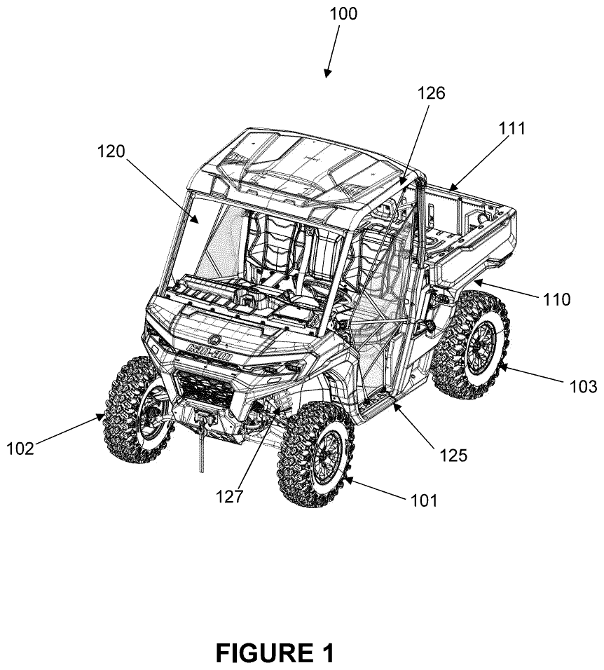

With regard to FIG. 1, there is illustrated a perspective view of a side-by-side vehicle (SSV) 100 for typical all terrain use and within which an embodiment of a heat shielding air funnel is intended to be used. The SSV 100 includes a frame 125 and an occupant compartment 120 where a driver and passenger(s) are normally located during use. The engine compartment 110 (hidden from view) is typically located adjacent to passenger compartment 120 and beneath the cargo bed 111. The SSV 100 comprises ground-engaging members to support the vehicle on the ground and engage the ground for traction of the SSV 100. In particular, the ground-engaging members 100 may comprise all-terrain tires 101, 102, 103 (fourth hidden from view) which, in some cases, may be located at extreme corners of the SSV 100 for stability. The all-terrain tires are suspended from front and rear portions of the frame 125 via front and rear suspension assemblies (front driver's side assembly 127 is visible though others are hidden from view).

It should further be understood that the SSV 100 includes elements to accommodate users including a cockpit area for the driver provided for within the occupant compartment 120 along with left and right seats. To maintain structural integrity and related occupant safety, a roll cage 126 is provided that is connected to the frame 125 and surround the occupant compartment 120 on all sides and from above.

The SSV 100 includes a vehicle body mounted to the frame 125 and includes elements such as, but not limited to a hood, front body panel(s), rear body panel(s), and side body panel(s). Laterally placed openings with or without doors are adjacent to the occupant compartment 120 in order to provide for ingress to and egress from the SSV 100. The cargo bed 111 may be in the form of a cargo box or cargo rack and mounted to the frame 125 in a rearward location relative to the occupant compartment 120. The cockpit area includes a steering device typically, though not limited to, a steering wheel which is connected to the front wheels 101, 102 through a series of steering linkages as is known in the mechanical art and not further described herein. Likewise, it should be understood that a “steer-by-wire” arrangement may also be possible whereby a steering device may be electrically connected to an actuator mechanism to actuate steering movement of the front wheels 101, 102 as is known in the electromechanical arts.

As should be readily apparent, the cockpit area will include a throttle and brake pedals for access by the driver. The SSV 100 includes a power train including a motor, and more specifically an internal combustion engine. However, it should be readily apparent that alternative power trains such as, but not limited to, one or more electric motor may be used to generate movement of the ground engaging members (e.g., wheels as shown). For further occupant safety, a firewall may be disposed between the occupant compartment 120 and the engine compartment 110 thereby shielding the driver and passenger(s) from the engine heat and preventing overheating of occupant seats and interior elements.

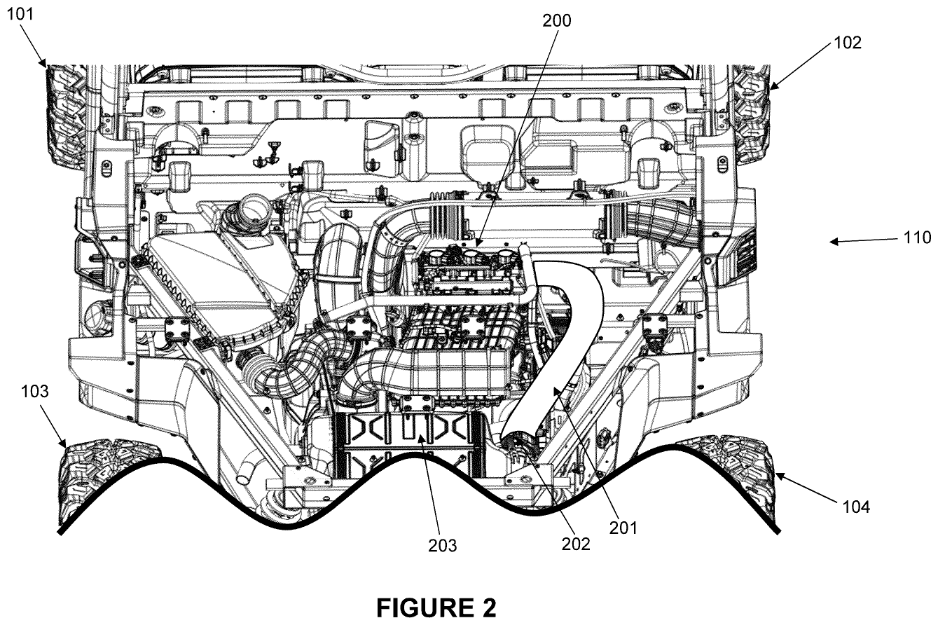

Because occupants are effectively located close to the engine and the CVT of the SSV 100 and due to the compactness of the engine and the CVT portions of the drive train, the heat generated by the engine and CVT is concentrated at a longitudinal portion of the SSV 100 that is adjacent to the cabin and beneath the cargo bed 111. Exhausts from the engine and air-cooled CVT exit the rear of the SSV 100 as further described with reference to FIG. 2. In one embodiment, the CVT may be disposed on a left side of the engine. A transaxle may be provided that is driven by CVT and connected to the back of the engine in order to provide motive force to at least two rear wheels. This may be accomplished via half shafts and may also include a driveshaft extending forwardly of the transaxle so as to drive a front differential and the two front wheels. Such details are well within the mechanical arts and not further described herein.

In instances of an internal combustion engine being used within the drivetrain of the SSV 100, it should further be understood that fuel to be delivered to the engine may be stored in a fuel tank that may be disposed anywhere within the frame 125 including, but not limited to, a side of the engine and in part rearward of the seat bases.

In this embodiment, the SSV 100 includes a configuration with a transverse engine—i.e., the cylinders of the engine are disposed laterally, as opposed to a longitudinal engine) with an air intake port on one side of the engine (on a CVT side), in a portion of the engine that is toward the rear of the vehicle, and an exhaust manifold (i.e., a component collecting exhaust gas from each cylinder of the engine toward the engine exhaust conduit) on a front side of the engine, between the rest of the engine and the passenger compartment. The engine exhaust is a conduit with an outer diameter of about 40 mm to 50 mm, more specifically about 45 mm. The CVT is operatively coupled to the engine output shaft and is disposed on one lateral side of the engine. The CVT has an air cooling system with a cooling air intake port on a top portion of the CVT, above a front portion of the CVT and above a drive wheel, and at least one cooling exhaust of the CVT. More particularly, in this embodiment, the air cooling system of the CVT comprises a first cooling exhaust on a front side of the CVT on the drive-wheel side, and a second cooling exhaust on a rear side of the CVT on the driven-wheel side. Together, the engine and the CVT are located behind the passenger compartment (i.e., behind the seats) and generally in a lateral center area of the SSV.

The present disclosed embodiment uses the CVT cooling exhaust gases to cool down and insulate the engine exhaust while providing a more compact assembly and while conducting the exhaust gases away from the passenger compartment as quickly and efficiently as possible. This is achieved by directing at least part of the CVT exhaust gases toward the engine exhaust. In particular, the disclosed embodiment forms a concentric conduit around the engine exhaust and part of, a majority of, or an entirety of the first CVT exhaust is directed into the concentric conduit to create an air flow around the engine exhaust. The concentric conduit may generally extend from the engine exhaust manifold to the muffler. In this case, the conduit first extends laterally to a side of the engine that is opposed to the CVT side of the engine. As will described and shown in more detail below, in this embodiment, the conduit then turns towards a longitudinal direction of the vehicle and extends beside the engine all the way to the muffler that is disposed behind the engine in the longitudinal direction of the SSV.

With regard to FIG. 2, there is shown a partial view of the rear engine compartment 110 of the SSV but with the cargo bed and heat plates removed for illustrative clarity. Here, a generalized schematic 201 indicating the heat shielding air funnel is seen extending from a front side of the engine block 200 in a longitudinal direction of the vehicle 100 towards the muffler 203. For purposes of orientation, it should be understood that front tires 101, 102 are visible as well as rear tires 103, 104. Thus, it should be readily apparent that the exhaust exit port 204 of the muffler exhaust pipe and the funnel exit port 202 of the heat shielding air funnel both terminate at a rear portion of the SSV so as to promote heat removal from the engine compartment away from the occupant compartment and also towards the rear perimeter of the cargo bed. This arrangement provides an effective method of directing CVT heat exchange gases away from the occupants and cargo bed. This is due to the method of shielding involved and ultimately forms an advantageous method of managing heat within an SSV. Each such method will be further described hereinbelow.

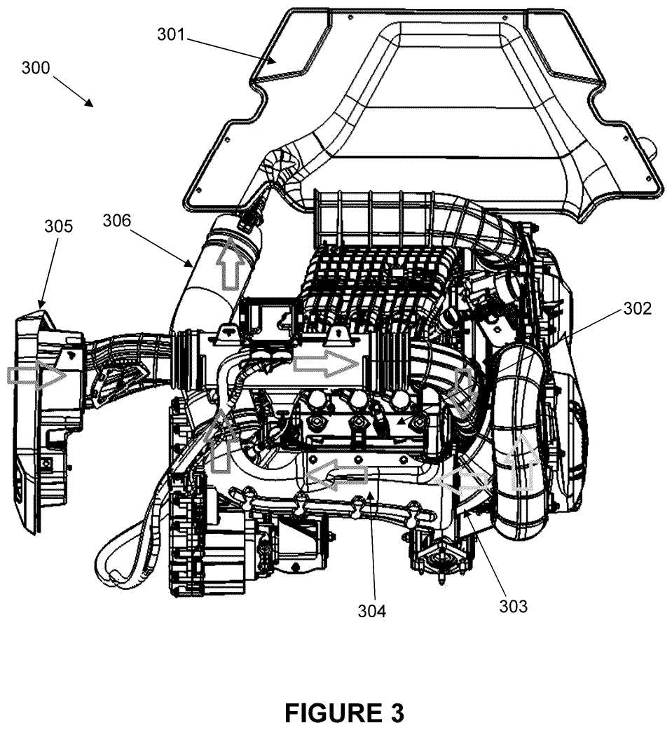

With regard to FIG. 3, there is shown a top view of an engine block for the SSV of FIG. 1 where an embodiment of the heat shielding air funnel in accordance with the present disclosure is installed. Here, it may be seen that the heat shielding air funnel generally includes a first section 304 which is attached over the engine exhaust manifold and a second section 306 which is attached concentrically around the engine exhaust pipe that extends from the engine exhaust manifold toward the rear of the SSV. The terminus of the second section 306 is located beneath a corner of the heat plate 301 which itself provides heat protection of the cargo bed from the engine and CVT exhausts. The engine exhaust pipe is a conduit and may have an outer dimension (e.g., an outer diameter, where the conduit is circular) of about 40 mm to 50 mm, more specifically about 45 mm.

The first section 304 is formed as a half-clamshell shape and which is attached to the engine block by fastening mechanisms such as, but not limited to, bolts, screws or resilient elements. In particular, in this embodiment, the first section 304 is connected to the engine block by at least two springs configured to retain the first section 304 in a manner that compensates for thermal expansion. The first section 304 is dimensioned to cover and thereby encapsulate the engine exhaust manifold. One end of the first section 304 is configured to accept the CVT exhaust pipe 303. Details of the CVT exhaust are well known and will not be further described in detail here. However, it should be noted that the CVT exhaust provides an egress for heated air that enters as ambient air at air intake 305 in order to air-cool the CVT via CVT intake conduit 302 and then exhausts through CVT exit conduit 302 into the first section 304. Because the CVT exhaust, albeit heated while extracting heat from the CVT, is considerably cooler than the engine exhaust manifold and engine exhaust piping coming from the manifold, the CVT exhaust provides an ability to wash over the engine exhaust and assist in cooling the engine exhaust piping. As previously mentioned, the CVT exhaust may range up to about 100° C. to 120° C. while the engine exhaust may range up to about 700° C. to 800° C.

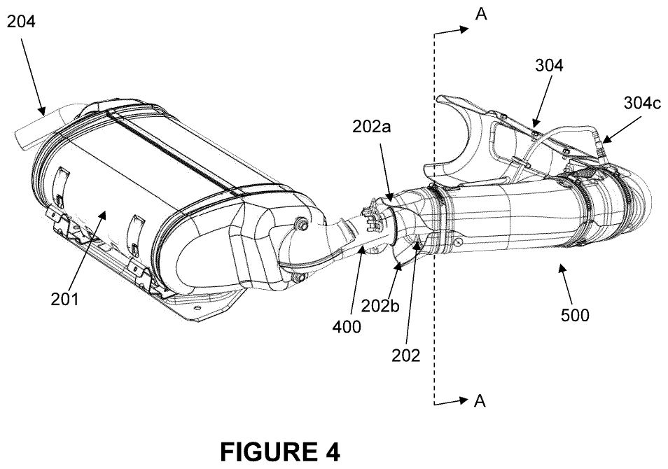

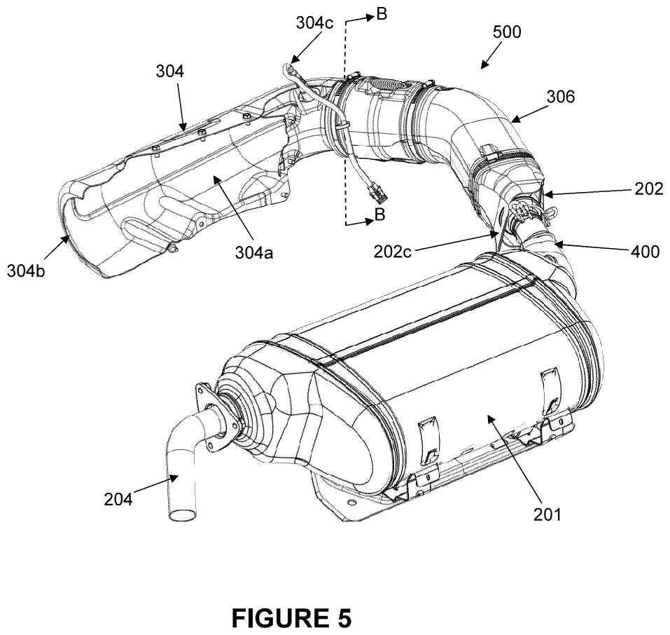

Once the first section 304 transitions into the second section 306, the structure changes from that of a half-clamshell shape to that of a full cylinder. This transition occurs at which point the engine manifold transitions completely into a single exhaust pipe. Thus, flow of CVT exhaust occurs from the first section 304 through the second section 306 to the intended terminus of the second section 306 located beneath the corner of the heat plate 301 as previously mentioned. When assembled in place atop the engine block, the first section 304 and the second section 306 form a heat shielding air funnel that generally encapsulates the engine exhaust extending from the CVT exhaust pipe across the engine exhaust manifold to just before the exhaust pipe entrance into the muffler as will be better shown and described with reference to FIGS. 4 and 5. In some embodiments, the heat shielding air funnel formed by the sections 304, 306 may extend around or adjacent to the exhaust pipe entrance into the muffler.

With regard to FIG. 4, there is shown a side perspective view of the embodiment of the heat shielding air funnel 500 with an associated muffler exhaust portion including an exposed section of the exhaust pipe 400, the muffler 201, and the engine exhaust terminus 204. Likewise, with regard to FIG. 5, there is shown a top perspective view of the embodiment of the heat shielding air funnel as shown in FIG. 4 with like elements numbered identically. In FIG. 5, the interior 304a of the first section 304 is clearly visible as the engine block (not shown) is disconnected therefrom. It should therefore be evident that the interior 304a is normally occupied by the engine exhaust manifold when the first section is bolted or otherwise attached to the engine block. Likewise, the first section includes a lip 304b onto which the CVT exhaust pipe (element 303 in FIG. 3) is normally fitted and retained in place in any known manner including, but not limited to, band clamp fittings or the like. When the first section 304 is attached to the engine block the interior 304a acts as a conduit for the relatively cooler CVT exhaust air to wash over the relatively hotter engine exhaust manifold as the CVT exhaust air travels from the CVT exhaust pipe 303 to the funnel exhaust port 202. In some embodiments, such as wherein the heat shielding air funnel extends around or adjacent to the exhaust pipe entrance into the muffler, the heat shielding air funnel may be configured to direct CVT exhaust air towards at least part of the muffler and its immediate environment, thus increasing convection and cooling the muffler and/or its environment.

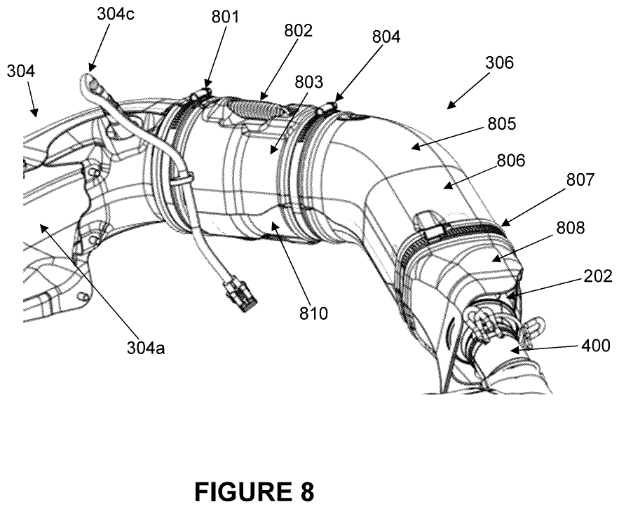

It should be noted that the first section 304 and the second section 306 that together form the heat shielding air funnel may include a plurality of interconnected portions. In this manner, fabrication of the overall heat shielding air funnel concentrically over the exhaust pipe 400 and engine exhaust manifold may be accomplished in an effective manner. Moreover, because the second section 306 is formed entirely surrounding the exhaust pipe 400, manufacture of the second section by way of the plurality of interconnected portions provides ease of assembly. In terms of the plurality of interconnected portions that may form the first section 304 and the second section 306, a more detailed description is provided hereinbelow with regard to FIG. 8.

It should be noted that the heat shielding air funnel formed by the first and second sections 304, 306 are located vertically within the engine compartment as high as possible, close to a surface of the cargo box, to prevent ground particles/debris from contacting the heat shielding air funnel during operation of the SSV. In particular, a vertical distance between the frame of the cargo box and the heat shielding air funnel is less than 25 cm and, more specifically, between 10 cm and 15 cm. The heat shielding air funnel is also spaced from other components of the SSV. It should be noted that the majority of the overall exhaust system is surrounded by a clearance area such that a majority or an entirety of the heat shielding air funnel is spaced from every other component of the vehicle (except the engine itself) by at least 10 cm to 25 cm.

With specific reference to the funnel exhaust port 202, it may be seen from FIGS. 4 and 5 that the terminus of the second section 306 includes flared edges 202a, 202b, and 202c that function as guides to direct CVT exhaust air outwards towards the rear of the SSV similar to the flared angle of the engine exhaust terminus 204. The funnel exhaust port 202 is therefore configured to direct CVT exhaust air generally toward the muffler of the SSV at the distal end thereof. The flared edges 202a, 202b, and 202c may themselves or in conjunction with additional airflow guides (not shown) form one or more element located proximate to the funnel exhaust port 202 and configured to split the airflow emanating from the CVT exhaust into at least two parts. For example, the heat shielding air funnel 500 may be configured to direct at the funnel exhaust port 202, the split airflow toward a first portion of the muffler and also toward a second portion of the muffler. Still further, the heat shielding air funnel 500 may be configured to direct the first part of the airflow toward the muffler and to direct the second part of the airflow toward another component of the vehicle.

Thus, in this embodiment, both hot CVT exhaust gas and engine exhaust gas exit from opposite sides of the rear of the SSV. Likewise, it should be readily apparent that engine exhaust gas and CVT exhaust gas do not directly mix together. Rather, the concentric nature of the pipe-within-a-pipe ensures that a portion of the engine exhaust structure from the manifold to just prior to the muffler is contained within and surrounded by the first and second sections that form the heat shielding air funnel. Such portion may be a length of at least 20 cm, more specifically at least 40 cm, more specifically at least 60 cm, or more specifically between 70 cm and 80 cm.

In terms of the relative amount of the heat shielding air funnel spanning the overall CVT cooling system exhaust path, it should be noted that this may vary in accordance with the given implementation. In some instances, the heat shielding air funnel spans over at least 30% of the overall CVT cooling system exhaust path. In other instance, this span may be at least 50%, at least 70%, or substantially over an entirety of the given CVT cooling system exhaust path. Likewise, in some instances, the heat shielding air funnel spans over at least 30%, at least 50%, at least 70%, or substantially over an entirety of the engine exhaust path between the exhaust manifold and the muffler.

A sensor 304c may be provided, for example, for monitoring oxygen concentration of the engine exhaust gases flowing in the engine exhaust pipe. In this case, the sensor 304c may be an O2 sensor. In some embodiments, the SSV 100 may also comprise a sensor for temperature monitoring of the CVT exhaust flowing in the space between the engine exhaust pipe and the heat shielding air funnel formed over the engine exhaust pipe. The flow of the CVT exhaust in such space may be laminar or turbulent depending upon the specific structures formed within this space. In particular, in this embodiment, the engine exhaust pipe and the heat shielding air funnel are configured so that the flow of the CVT exhaust in this space is turbulent to increase heat transfer between the engine exhaust structures and the CVT exhaust gases. In particular, in some embodiments, an air speed of the CVT exhaust in the space 600 may be at least 10 m/s, in some embodiments at least 15 m/s, and in some embodiments at least 20 m/s. Likewise, an air flow of the CVT cooling system exhaust gases through the CVT conduits (302 and 303 in FIG. 3) may be, in some embodiments, at least 90 CFM (153 m³/h), in some embodiments at least 135 CFM (230 m³/h), and in some embodiments at least 180 CFM (305 m³/h). As well, the engine exhaust flow through the manifold and exhaust pipe may be, in some embodiments, at least 200 kg/h, in some embodiments at least 250 kg/h, and in some embodiments at least 290 kg/h or alternatively at least 500 m³/h, in some embodiments at least 625 m³/h, and in some embodiments about 750 m³/h. In other embodiments, the engine exhaust pipe and the heat shielding air funnel may be configured so that the flow of the CVT exhaust in this space is laminar to reduce noise and vibrations or turbulent to increase heat transfer between the engine exhaust structures and the CVT exhaust gases. An advantage of the present embodiment is that the CVT exhaust gases effectively cool down and insulate the engine exhaust (i.e., manifold and piping) while providing a more compact assembly, and while conducting the CVT exhaust gases away from the operator area as quickly and efficiently as possible.

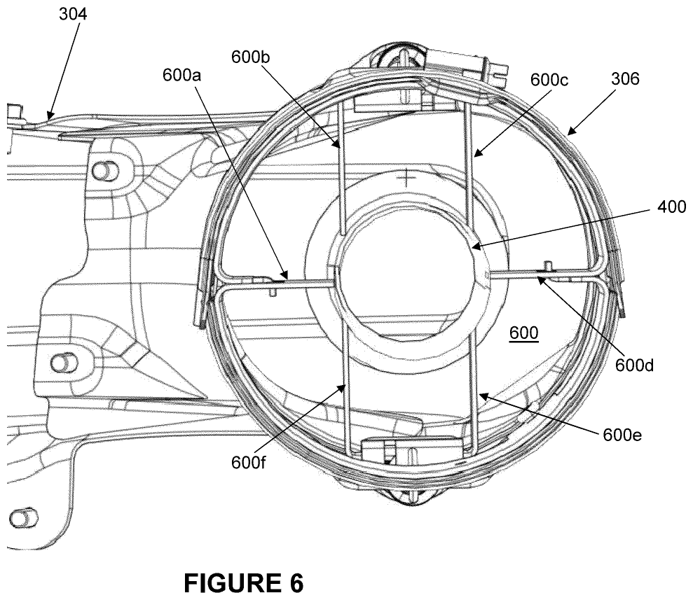

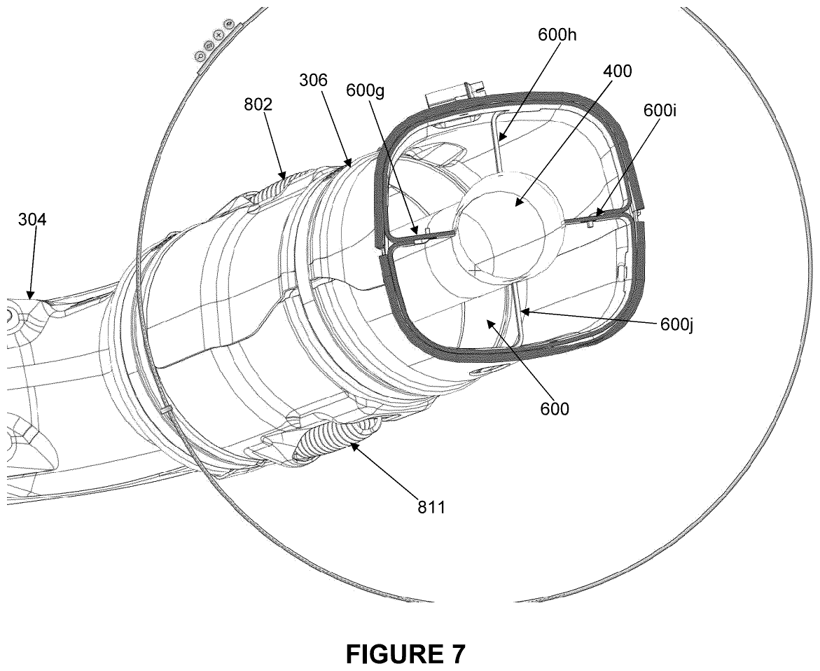

Reference will now be made to FIGS. 6 and 7 with further regard to the CVT exhaust flowing in the space 600 between the engine exhaust pipe 400 and the heat shielding air funnel (seen here as second section 306 with a portion of the first section 304) formed over the engine exhaust pipe 400. FIG. 6 is an end view taken from the cross section B-B in FIG. 5, while FIG. 7 is an end view taken from the cross section A-A in FIG. 4.

With specific reference to FIGS. 6 and 7, the concentric nature of the engine exhaust pipe 400 retained within the walls of the second section 306 is shown. While the specific structure in the embodiment shown that retains a connection between the engine exhaust pipe 400 is seen as a plurality of reinforcements, and more specifically inner braces 600a through 600f in FIG. 6 and inner braces 600g through 600j in FIG. 7, any suitable number or configuration of inner braces may be possible without straying from the intended scope of the present invention.

Indeed, the shape, position, and number of inner braces may vary in accordance with the desired flow of cooling air through space 600 so long as suitable and effective flow occurs.

As previously discussed and with regard to FIG. 8, it should be noted that the first section 304 and the second section 306 that together form the heat shielding air funnel may include a plurality of interconnected portions. Such interconnected portions facilitate assembly and also may advantageously compensate for heat expansion of the material that forms the heat shielding air funnel. Such material typically being any metal with suitable capacity to withstand high heat including, but not limited to, steel, aluminum, or alloys thereof. Heat expansion among the constituent parts that form the plurality of interconnected portions may be addressing in a variety of ways without straying from the intended scope of the present invention where one possible embodiment is shown and described in more detail with regard to FIG. 8.

FIG. 8 shows a close-up portion of the heat shielding air funnel that includes a partial view of the first section 304 and its interior 304a at one edge of the figure and a partial view of the exhaust pipe 400 preceding the muffler (not visible) at the other edge of the figure. While the first section 304 may be integrally formed (i.e., unitary) and partially open along one length thereof and configured as a clamshell-like structure from a single piece of material (e.g., stamped steel or the like) and is attachable to the engine block thereby encapsulating the engine manifold as previously discussed, the second section 306 may be configured in multiple interconnected portions in order to facilitate assembly of the second section 306 around the exhaust pipe 400 in a concentric manner as previously discussed. For example, the second section 306 as shown includes a bottom portion 810 and top portion 803 which, when combined form a complete generally cylindrical shape in order to surround the exhaust pipe 400 thereby concentrically surrounding the exhaust pipe 400.

Additionally, portions 805, 806, and 808 may be formed as a unitary extension of the top portion 803. Likewise, the bottom section 810 may extend beneath portions 805, 806, and 808 in a similar manner. As may be seen, the portion 808 is flared to include an opening which serves to function as the funnel exit port 202 as previously described. The top and bottom portions 803, 810 may be held in place via band clamps 801, 804, 807 as shown or any suitable manner of retaining in place the one or more portions that form the second section 306. Still further, in order to limit mechanical load variations due to temperature and gas flow variations during use, the constituent parts of the second section 306 may include resilient elements at the proximal end of the second section 306 opposite to the distal end of the second section 306 where the funnel exit port 202 is located. The resilient element may include a pair of springs 802 and 811 (visible in FIG. 7 though hidden in FIG. 8). The springs 802 and 811 are configured to retain together the constituent parts of the second section 306 in a manner that compensates for thermal expansion. Likewise, the constituent parts of the second section 306 may include resilient elements at the distal end of the second section 306 where the funnel exit port 202 is located, to connect the second section 306 to the muffler to further support the second section 306. The resilient element may include a pair of springs configured to retain together the constituent parts of the second section 306 in a manner that compensates for thermal expansion.

It is contemplated that the vehicle 100 of FIG. 1 may be implemented in various other ways. For instance, in some embodiments, the vehicle 100 of FIG. 1 may have a configuration with a longitudinal engine.

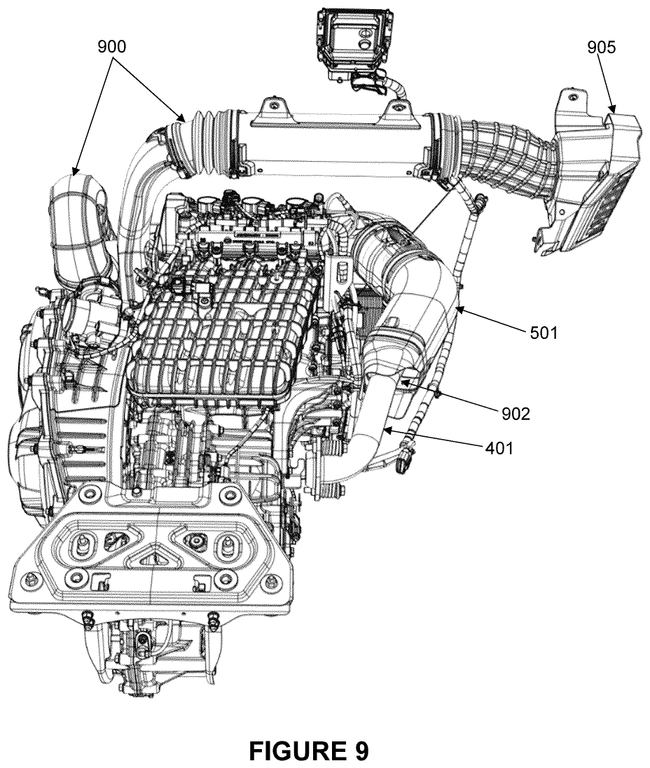

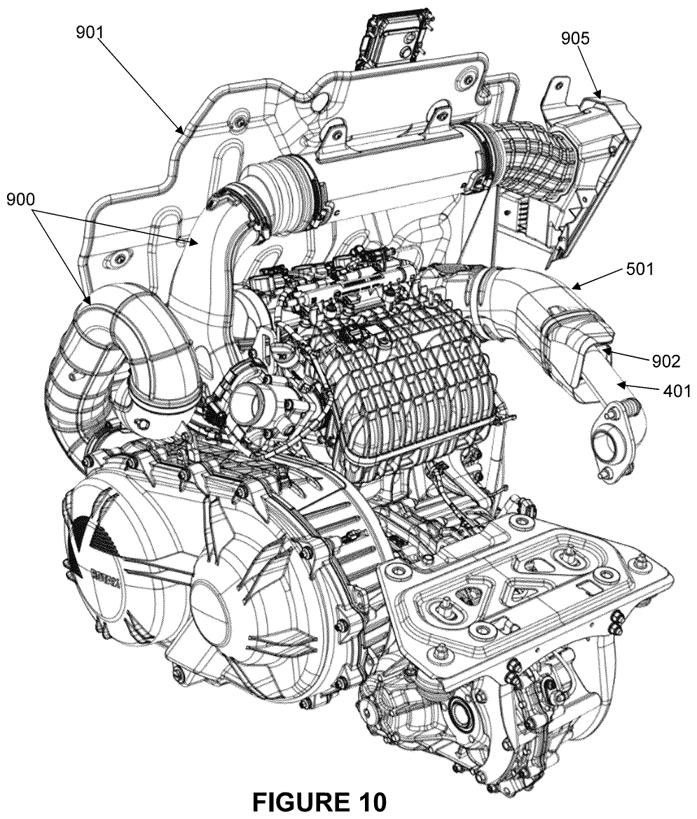

As another example, in some embodiments all CVT exhaust gases are concentrated around a single outlet as shown in FIGS. 9 and 10. FIG. 9 is rear view of another embodiment of the heat shielding air funnel within an engine having a single exhaust CVT. FIG. 10 is side perspective view the embodiment shown in FIG. 9 though shown with a firewall 901 in place. Here, the air cooling system 900 of the CVT may comprise a single cooling exhaust 902 on the rear side of the CVT, and more specifically on the driven-wheel side of the CVT. In this example, the CVT air intake 905 cools the CVT and subsequently all of the CVT exhaust gases are directed at an exit port 902 toward the engine exhaust during SSV operation via the concentric conduit 501 around the engine exhaust pipe 401. In this manner, all exhaust gases are concentrated around a single outlet.

The embodiments described above are intended to be exemplary only. The scope of the invention is therefore intended to be limited solely by the appended claims.

1. A heat management apparatus for use in a side-by-side off-road vehicle having an engine and a continuously variable transmission (CVT) including a cooling system with a CVT cooling intake and a CVT cooling exhaust, the apparatus comprising:
a first section partially open and attachable to an engine exhaust manifold of the engine, the first section having a first end and a second end, the first end configured for engagement with the CVT cooling exhaust;
a second section arranged concentrically around a portion of an exhaust pipe that extends from the engine exhaust manifold to an area near a muffler of the vehicle, the second section attached to the second end of the first section; and
upon attachment of the first section to the engine exhaust manifold, the first section and the second section form a flow path surrounding the engine exhaust manifold and at least a portion of the exhaust pipe.

2. A side-by-side off-road vehicle comprising:
an engine having an engine exhaust manifold, an exhaust pipe extending from the manifold, and a muffler attached to the exhaust pipe at a distance from the manifold, and the manifold and exhaust pipe form an engine exhaust conduit;
a continuously variable transmission (CVT) including a CVT cooling system with a CVT cooling intake and a CVT cooling exhaust:
a heat shielding air funnel having
a first section engaging the manifold, the first section having a first end and a second end, the first end engaging the CVT cooling exhaust, and
a second section arranged concentrically around a portion of the exhaust pipe between the manifold and the muffler, the second section attached to the second end of the first section; and
the first section and the second section form a flow path surrounding the engine exhaust manifold and the portion of the exhaust pipe.

3. The vehicle as claimed in claim 2, wherein at least part of the CVT cooling exhaust spans over at least 30%, or substantially over an entirety of the flow path.

4. The vehicle as claimed in claim 2, wherein the CVT cooling exhaust is configured to cool engine exhaust gases along at least a segment of the exhaust conduit.

5. The vehicle as claimed in claim 2, wherein a maximum outer temperature of the heat shielding air funnel is no more than 120° C. along a majority or an entirety of the exhaust conduit.

6. The vehicle as claimed in claim 5, wherein the second section further includes at least one reinforcing element extending radially between the exhaust pipe and the inner wall of the second section to maintain the second section in place.

7. The vehicle as claimed in claim 2, wherein the first section and the second section are connected by resilient elements.

8. The vehicle as claimed in claim 7, wherein the resilient elements are springs.

9. The vehicle as claimed in claim 7, wherein the resilient elements are configured to limit mechanical load variations due to temperature and gas flow variations during use of the vehicle.

10. The vehicle as claimed in claim 2, wherein the engine and the CVT are transverse.

11. The vehicle as claimed in claim 2, wherein an exit port of the heat shielding air funnel is configured to direct CVT exhaust air generally toward a rear of the vehicle at a distal end of the second section.

12. The vehicle as claimed in claim 2, wherein an exit port of the heat shielding air funnel is configured to direct CVT exhaust air generally toward the muffler.

13. The vehicle as claimed in claim 12, wherein the second section includes an element proximate to a distal end of the second section, the element configured to split airflow emitted from the flow path into at least a first part and a second part.

14. The vehicle as claimed in claim 13, wherein the second section is configured to direct the first part of the airflow toward a first portion of the muffler and to direct the second part of the airflow toward a second portion of the muffler.

15. The vehicle as claimed in claim 13, wherein the second section is configured to direct the first part of the airflow toward the muffler and to direct the second part of the airflow toward another component of the vehicle.

16. The vehicle as claimed in claim 2, wherein the muffler extends laterally such that air flows in the muffler generally in a lateral direction of the vehicle.

17. The vehicle as claimed in claim 2, wherein the muffler outputs air flow on a side of the muffler.

18. The vehicle as claimed in claim 2, wherein the muffler outputs air flow toward a rear of the vehicle.

19. The vehicle as claimed in claim 2, wherein the heat shielding air funnel is configured to create a turbulent flow around at least part of the engine exhaust conduit to manage temperature of the engine exhaust conduit.

20. A vehicle with a powertrain having a periphery and including an engine and a transmission, the vehicle comprising:
a plurality of exhaust ports;
a plurality of exhaust locations along the periphery, each location being where exhaust conduits of the engine and the transmission each intersect the periphery to direct exhaust gases outside of an area occupied by the powertrain; and
the number of exhaust ports is greater than the number of exhaust locations.
